(19) United States
(12) Patent Application Publication
(10) Pub. No.: US 2018/0285899 A1
(43) Pub. Date: Oct. 4, 2018

(54) SYSTEM AND METHOD OF DETERMINING AND PROVIDING REWARDS

(71) Applicants: Harun Yayli, Fremont, CA (US); Geoff Penman, Woodside, CA (US)

(72) Inventors: Harun Yayli, Fremont, CA (US); Geoff Penman, Woodside, CA (US)

(21) Appl. No.: 15/939,182

(22) Filed: Mar. 28, 2018

Related U.S. Application Data
(63) Continuation-in-part of application No. 15/808,791, filed on Nov. 9, 2017, now abandoned.
(60) Provisional application No. 62/419,799, filed on Nov. 9, 2016.

(51) Int. Cl. G06Q 30/02

(52) U.S. Cl. CPC G06Q 30/0201; G06Q 30/0207

(57) ABSTRACT

A system and method for determining and/or providing rewards without requiring a consumer having to register individual purchases. In some embodiments, there is described a system that requires no additional Point of Sale (POS) hardware to implement a loyalty program, and no additional POS process to capture transactions associated with a loyalty program.

### CROSS-REFERENCE TO RELATED APPLICATIONS

This Application is a continuation-in-part of prior filed and co-pending patent application Ser. No. 15/808,791 filed Nov. 9, 2017 which claims the benefit of priority under 35 U.S.C. § 119(e) from earlier filed U.S. Provisional Application Ser. No. 62/419,799, filed Nov. 9, 2016, the entireties of each of which are each hereby incorporated herein by reference.

### BACKGROUND

### Technical Field

The present disclosure relates generally to the field of determining and/or providing rewards to a consumer.

### Related Art

In recent years rewards programs offered through banks and merchants have become prolific. However, all these individual programs require that users register purchases with the individual merchants or with the party providing the reward. What is needed is a system and method for determining and/or providing rewards without requiring a consumer to register individual purchases. Moreover, what is needed is a system that requires no additional Point of Sale (POS) hardware to implement a loyalty program, and no additional POS process to capture transactions associated with a loyalty program.

### BRIEF DESCRIPTION OF THE DRAWINGS

Further details of the present invention are explained with the help of the attached drawings in which:

FIG. 1 depicts a high-level overview of an embodiment of a system and method for determining and/or providing a consumer with a reward.

FIG. 2 depicts an embodiment of the system and method for determining and/or providing a consumer with a reward as depicted in FIG. 1.

FIG. 3 depicts an embodiment of the payout/reward system and a system and method for delivering rewards to a consumer.

FIG. 4 depicts a structural architecture on which the system and method of FIGS. 1-3 can be implemented.

### DETAILED DESCRIPTION

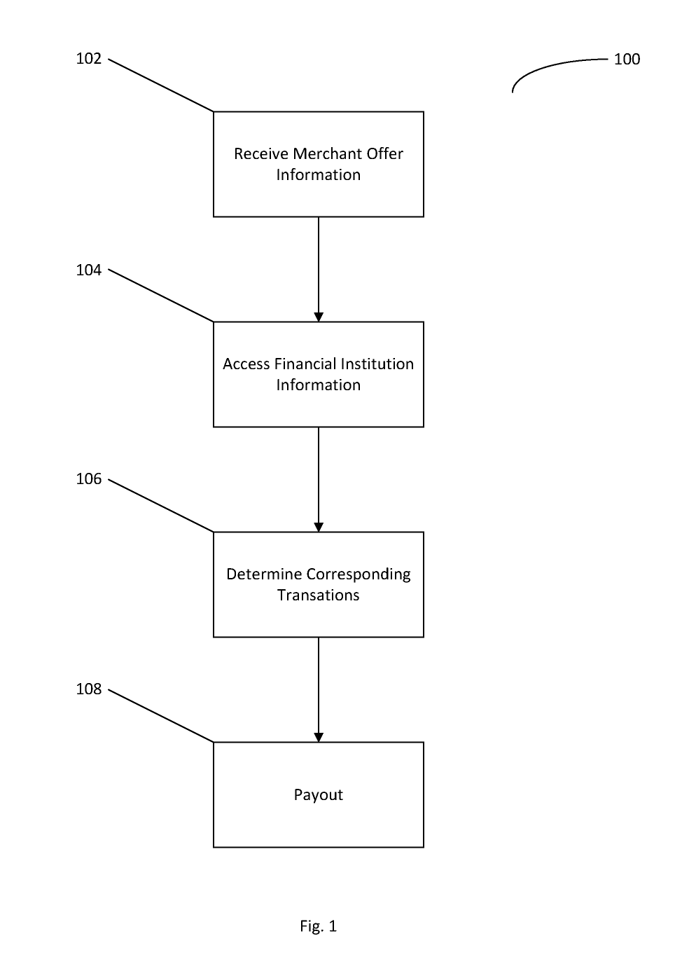

FIG. 1 depicts a high-level overview of an embodiment of a system and method 100 for determining and/or providing a consumer with a reward. In the embodiment depicted in FIG. 1, the system and method 100 comprises the steps of receiving merchant offer information 102, accessing financial institution information 104, determining corresponding transactions 106 and paying out rewards 108. However, in some embodiments one or more of the steps may be augmented and/or omitted.

In the embodiment depicted in FIG. 1, the system and method 100 can begin with the step of receiving merchant offer information 102. In some embodiments, merchant offer information can comprise specific information related to rules associated with a customer receiving a reward from a merchant. By way of non-limiting example, such specific information can include a required minimum number of transactions within a prescribed period of time and/or a certain minimum number of dollars spent within a prescribed period of time and/or, a required minimum dollar amount spent in a single transaction, and/or any other known, convenient and/or desired rule, restriction and/or limitation related to a consumer receiving a reward.

In step 104 of the system and method 100, financial information of the consumer is accessed. In some embodiments, the system and method 100, the financial information can be periodically accessed by an outside source such as a merchant's system and/or any other known, convenient and/or desired source or sources. However in alternate embodiments, the financial institution that maintains the financial information can periodically, and/or upon receiving new information, transmit the information. In some embodiments of the system and method 100, the financial information can comprise information regarding the merchant, the amount, the date and/or any other known and/or convenient information available and/or desired.

In step 106, the system and method 100 can determine whether any one or more individual transactions within the information received correspond to and/or fulfill the requirements of the merchant offer information 102.

In step 108, the system and method 100 can payout and/or issue a reward to a consumer consistent with the merchant offer information 102. In alternate embodiments, the system and method 100 can log and/or notify the consumer that a reward is available and/or is capable of being issued. In some embodiments, the system and method 100 can deliver the reward to the consumer without any action required by the consumer.

In some embodiments, a merchant can change and/or modify the merchant offer information at any time and/or create new merchant offer information and can retroactively institute the system and method 100 on transactions which occurred prior to the change, modification or addition. In still further embodiments, a merchant can change and/or modify the merchant offer information at any time and/or create new merchant offer information and can retroactively institute the system and method 100 on transactions which occurred within a prescribed time period prior to the change, modification or addition.

FIG. 1 depicts a high-level overview of an embodiment of a system and method 100 for determining and/or providing a consumer with a reward. In the embodiment depicted in FIG. 1, the system and method 100 comprises the steps of receiving merchant offer information 102, accessing financial institution information 104, determining corresponding transactions 106 and paying out rewards 108. However, in some embodiments one or more of the steps may be augmented and/or omitted.

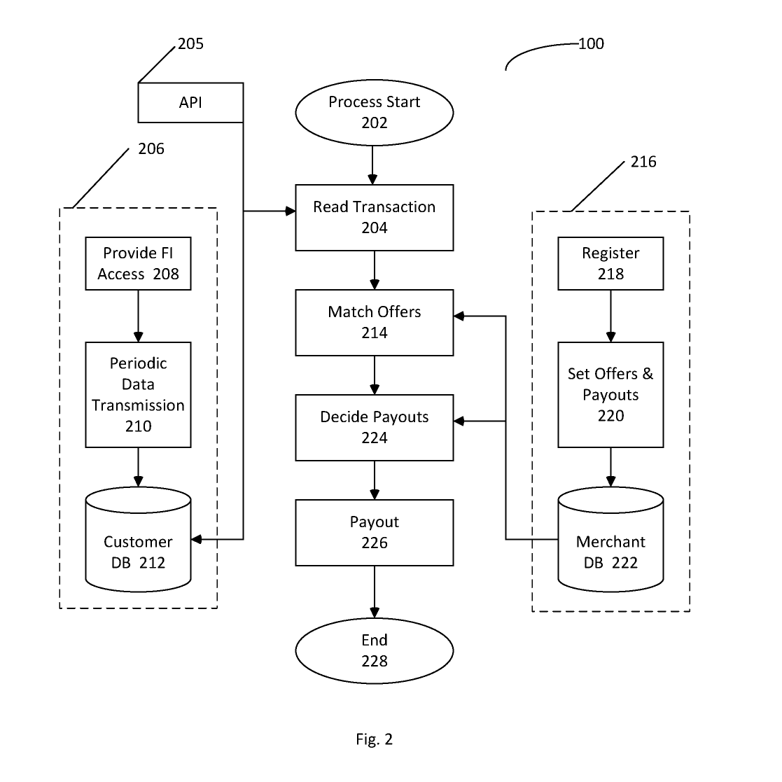

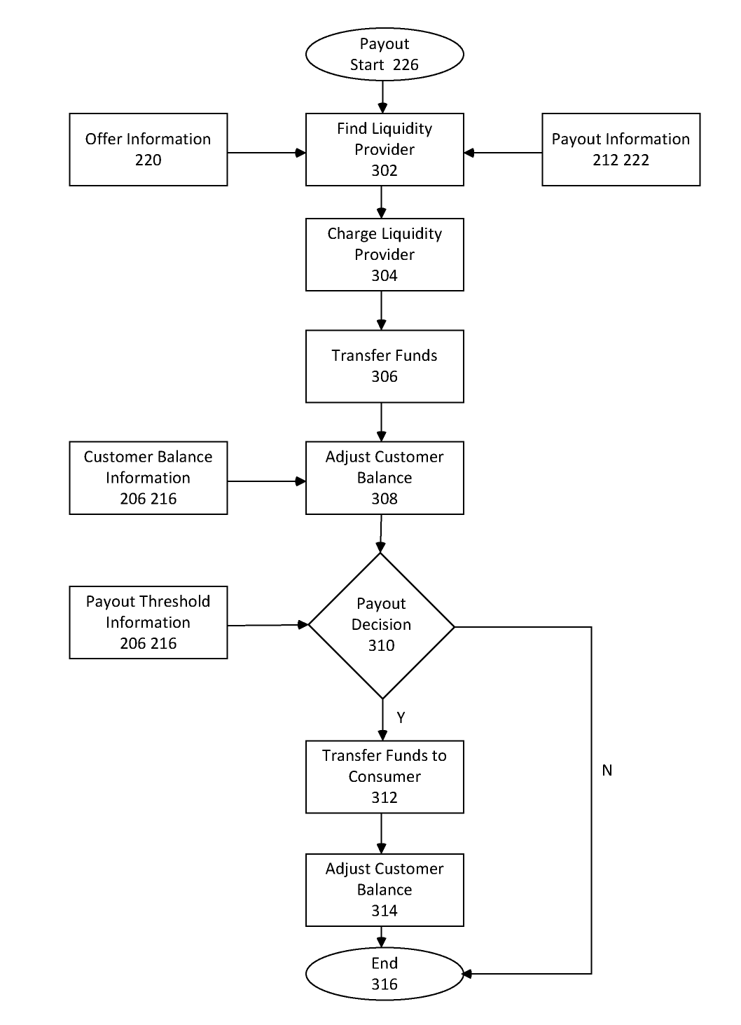

In the embodiment described in FIG. 1, ‘Receive Merchant offer information’ step 102 depicts a sub-system that allows the system 100 to receive merchant offer information. Merchant offer information can be comprised of the criteria of a transaction that is likely to be made by the consumer, of which the merchant desires to reward. The merchant offer information can contain criteria such as minimum transaction amount, the date and time of the transaction, location of the purchase, or any other known and/or convenient criteria that can be recognized by the financial institution at the time of the transaction or added later where the consumer is allowed access to the system 100. Criteria can also be determined based on the previous history of transactions made by the consumer. Such merchant offer information 102 can be collected and implemented using a user interface built using a web page and/or a mobile application connected to a computer database. Such computer database may be the same merchant database depicted in FIG. 2 as ‘Merchant DB’ 222. Merchant offer information can be kept in records containing an unlimited number of criteria made available by the transaction information provided by step 104 the ‘Financial Institution Information’ where the consumer is allowed access to the system 100.

In the embodiment described in FIG. 1., step ‘Access Financial Institution Information’ describes a series of steps completed by the consumer to allow the system and method 100 to gain access to the list of transactions made by the consumer using a financial institution service such as credit cards, debit cards and/or checks or any other means of transaction. In step 104 Access Financial Institution Information, the system and method 100 using the permissions provided by the consumer can access the Financial Institutions system(s) where the transaction record(s) are kept. Step 104, access to financial institution information can be implemented directly using the programming interfaces provided by the financial institution(s), or using any other third-party aggregator service which has access to financial institution transaction records. The consumer may allow access by the system and method 100 to the financial institution's records by means of providing their username and passwords or any other means of access permissions allowed by the financial institution. The system and method 100 can access these records at random, or periodically, as described in more detail in relation to the FIG. 2 sub-system 206.

In the embodiment described in FIG. 1. step 106 Determine Corresponding Transactions describes a series of steps completed by the system 100 as described in more detail in FIG. 2. Determining the corresponding transactions can be implemented as a parallel or series operation wherein the system and method 100 compares each record of transaction with merchant offer information 102. The comparison can be comprised of comparing each element of the transaction details such as merchant name or merchant identifier to the merchant offer information defined and set by the merchant in subsystem as described in more detail in FIG. 2. When a transaction is identified and determined to match merchant offer criteria the system and method 100 can provide a payout established by the merchant, then the system and method 100 can proceed to the series of operations depicted and described in FIG. 3.

In the embodiment described in FIG. 1. Payout 108 can be a series of steps performed by the system and method 100 where a certain reward is afforded to the consumer. In some embodiments, a reward can be a monetary payout with an amount determined by the merchant. However, in alternate embodiments, the reward can be of any known, convenient, and/or desired form. Payout 108 can be paid out to consumer using bank transfers directly arranged by a correspondent bank or any other system that permits rewards or money transfers between bank accounts. Payout 108 can follow certain criteria determined by the merchant such as a designated liquidity owner, where a designated liquidity provider can provide funds for one or more merchants. The system and method 100 can keep a balance of all awarded rewards and can provide the payout based on several different criteria such as minimum amounts to transfer or any other action can be determined by the system and method 100 or merchant.

FIG. 2 depicts an alternate embodiment of the system and method 100 for determining and/or providing a consumer with a reward as depicted in FIG. 1. In the embodiment depicted in FIG. 2, the system and method 100 can comprise of the steps of commencing the process 202, reading transactions 204 which can be accessed through a customer sub-system-and-method 206, matching offers 214 which can be accessed through a merchant sub-system-and-method 216, deciding payouts which can be accessed through the merchant sub-system-and-method 216, generating payouts 226 and termination 228 of the system and method 100.

In the embodiment depicted in FIG. 2, the step of reading transactions 204 can be accessed through the customer sub-system-and-method 206. The customer sub-system-and-method 206 can comprise the steps providing financial information access 208, periodically transmitting data 210 and creating and/or modifying and/or updating a customer database 212. In the step of providing financial information access 208, a customer can grant access to financial information which can be stored at one or more financial institutions. The information can be in electronic form and stored in any known, convenient and/or desired electronic form and can be banking information of any form that relates to transaction with various merchants. After a consumer grants access to the financial information in step 208, the financial information can be periodically transmitted to a customer database 212 and/or can bypass the customer database 212 and the financial information can be directly delivered to step 204. Additionally, in some embodiments, periodic transmission 210 can be triggered at desired time intervals set by the consumer, the financial institution and/or the system and method 100 and/or can be sent upon the receipt of a new transaction by the financial institution.

In the embodiment depicted in FIG. 2, the step of matching offers 214 can be accessed through the merchant sub-system-and-method step 216. The merchant sub-system-and-method step 216 can comprise the steps of registering one or more merchants 218, setting one or more merchant offers and/or payouts 220 and creating and/or modifying and/or updating a merchant database 222.

In the step of providing registering one or more merchants 218, a merchant can provide information regarding itself which can comprise financial or other information for fulfillment of payouts of rewards. The information can be in electronic form and stored in any known, convenient and/or desired electronic form and can be banking or other information of any form that relates to payouts and/or reward fulfillment. After a merchant registers in step 218, the merchant can establish, modify and/or update rules, restrictions and/or conditions upon which a customer may receive a reward or payout and such information can be stored in a merchant database 222 and/or can bypass the merchant database 222 and the reward/payout information can be directly delivered to step 214 and/or step 224.

In step 224 a payout decision can be determined based on the rules, restrictions and/or conditions upon which a customer may receive a reward of payout, based on a comparison of information received from the merchant sub-system-and-method 216 and the customer sub-system-and-method 206. In some embodiments merchant offer information 220 can comprise specific information related to rules associated with a customer receiving a reward or payout from a merchant. By way of non-limiting example, such specific information can include a required minimum number of transactions within a prescribed period of time and/or a certain minimum number of dollars spent within a prescribed period of time and/or, a required minimum dollar amount spent in a single transaction, and/or any other known, convenient and/or desired rule, restriction and/or limitation related to a consumer receiving a reward or payout.

In some embodiments, a merchant can change and/or modify the merchant offer information 220 at any time and/or create new merchant offer information 220 and can retroactively institute the system and method 100 on transactions which occurred prior to the change, modification or addition. In still further embodiments, a merchant can change and/or modify the merchant offer information 220 at any time and/or create new merchant offer information and can retroactively institute the system and method 100 on transactions which occurred within a prescribed time period prior to the change, modification or addition.

Additionally in alternate embodiments, the step of matching offers can be performed by one or more financial institutions and only financial information related to matching offers can be transmitted to step 224. In such embodiments, information from step 220 and/or the merchant sub-system-and-method 216 can be delivered to the one or more financial institutions and/or the customer sub-system and method 206 such that the step of matching 214 can be performed by the customer sub-system and method 206.

In the step 226, the payout process 226 can be initiated and the system and method 100 can proceed to the end step 228.

In the embodiment described in FIG. 2, a system and method for determining and/or providing a consumer with rewards is depicted wherein the entire process of determining and/or providing rewards starts with a step Process Start 202. Process Start 202 can be implemented based on a timer or can start as a trigger initiated by system 100 with a predetermined regularity of the time, day or date. Process start 202 can be also be initiated manually.

In the step 204 depicted in FIG. 2. the Read Transactions step describes the series of operations performed by the system and method 100 to iterate through each record of purchase transactions made by the consumer. In step 204, previously captured transaction records can be read from one or more consumer databases depicted in FIG. 2., i.e. Consumer database 212. Also, in step 204 Read Transactions can be implemented by an application programming interface 205 provided by the system and method 100 to the financial institution of the consumer or to any other party that has knowledge of the transaction. The transaction information can be pushed to the system and method 100 through the application programming interface 205 so that the system and method 100 and/or by access to the consumer database 212. In embodiments wherein an application programing interface 205 is used, the system and method 100 can record the transaction to Consumer Database 212.

In some embodiments, each transaction information record can contain the size of the transaction, time and date of the transaction, merchant or receiving party of the transaction and/or other related information provided by the financial institution recorded at the time of the transaction or later recorded.

In the step 214 depicted in FIG. 2. the step of Match Offers describes an operation wherein the system and method 100 can compare and/or match each transaction record to the merchant offer information sourced by the Merchant database 222. Matching can be implemented by comparing each transaction record's merchant name and/or merchant identifier, and/or any other criteria set by the merchant such as minimum transaction mount, the date and time of the transaction, location of the purchase, or any other criteria that can be recognized by the financial institution. When an offer is matched to a transaction, the system and method 100 can move to step Decide Payouts 224.

In the step 224 depicted in FIG. 2. at the step of Decide Payout, the system and method 100 can determine which reward(s) can be provided to the consumer. The payout information can be set by the merchant and can be kept in a database such as Merchant database 222. Each record of Payout information can contain the information for the liquidity provider, amount of the reward, currency and other information relevant to the payout such as the liquidity provider's bank account information, and preferred method of payment.

In the step 226 depicted in FIG. 2. the step of Payout describes a series of operations performed by the system and method 100 to provide a reward to the consumer.

In the step 228 depicted in FIG. 2. the step of End describes the conditions to stop the process of matching transactions and merchant offers. The process can stop when there are no more consumer transactions left to process and/or at will when triggered manually or automatically.

The sub-system depicted in the FIG. 2, 206 describes the steps performed by system and method 100 wherein financial institution(s) or other transactional information is obtained 208, and periodically transferred 210 to a customer database 212. Step 206 can be used to capture customer transactions to compare against merchant offers as described in relation to step 216 to determine if a payout can be triggered.

In the step 208 depicted in FIG. 2. the step of Provide FI Access 208 describes a system and method 100 by which customer(s) can give access to financial institution information wherein individual transactional information can be accessed. This access can be implemented programmatically by granting access to directly attach to each specific financial institution's API's if available, or can be implemented by granting the system and method 100 access to various financial institution's transactional information via a third-party agreement or application, and/or to attach a financial institution's transactional information by any other system, method or series of steps wherein the system and method 100 is granted permission to do so.

In the step 210 depicted in FIG. 2, the step of Periodic Data Transmission describes the process of transmitting transactional information from a financial institution to a customer database in periodic increments. In some embodiments, this can be implemented as either a ‘push’ or ‘pull’ process at regular intervals based on specific times, an on-demand process initiated either from the financial institution, and/or by a process, triggered by the financial institution and delivered to the database, triggered by the customer and/or triggered by matching a set of variables or by transaction variables such as value, merchant ID, or any other known, convenient and/or desired variable captured at purchase.

Customer database 212 depicted in FIG. 2. can be a database that can be created to store customer transactional data. The customer data can be collected through internal, external, and/or business partner data sources. The database can be used to store customer data and can be any known data storage mechanism. In some embodiments it can be a relational database sometimes referred to as a data warehouse. In some embodiments, a data warehouse platform used for storing customer data can be powered by known, convenient and/or desired data storage platforms. The Customer database 212 can be a transactional subset of a broader central customer information system (“CCIS”) and can include a relationship profile component, an account management component, a lead management system, a sales tracking and reporting (management information system or “MIS”) component and transactional information. Customer Database 212 may include information concerning existing customer financial information, information from outside sources and/or demographic information about existing and/or potential customers. Information transmitted to Customer Database 212 can include, but is not limited to, all financial transactions types, associated amounts, transaction dates and times, merchant names and/or ID's, associated demographic information about the merchant, customer and financial institution, currency, exchange rates, and/or any other information available via the connectivity associated with Provider Access 208.

The sub-system depicted in FIG. 2, 216 describes the steps performed by the system and method 100 wherein individual merchants can register an account, identify liquidity provider for merchant or per offer, link payment information and/or financial accounts, update specific information about their business, set specific offers and associated payouts.

Step 218 depicted in FIG. 2. as the step of Register describes the process wherein a merchant can initiate the setup of an account, inputs detail about a business including, but not limited to, business name, business locations, liquidity provider and associated financial account information, tax status with associated information, and contact details. The capture method according to some embodiments can be online via a website, with a specific merchant portal. Other embodiments could be via a mobile device and/or application. Further embodiments could be via direct input from another system, documentation or communication medium. This information can then be transferred and stored in Merchant Database 222.

Step 220 depicted in FIG. 2. as the step of Set Offers & Payouts describes a process wherein a merchant inputs offers and associated payout information. In some embodiments, one method to capture information can be via a merchant portal with direct input. In alternate embodiments, another method can be via the assistance of a sales representative via standard communication techniques. In still further embodiments, another method can be a mobile device app. In some embodiments merchant offer information 220 can comprise specific information related to rules associated with a customer receiving a reward or payout from a merchant. By way of non-limiting example, such specific information can include a required minimum number of transactions within a prescribed period of time and/or a certain minimum number of dollars spent within a prescribed period of time and/or, a required minimum dollar amount spent in a single transaction, and/or any other known, convenient and/or desired rule, restriction and/or limitation related to a consumer receiving a reward or payout. In some embodiments, a merchant can change and/or modify the merchant offer information 220 at any time and/or create new merchant offer information 220 and can retroactively institute the system and method 100 on transactions which occurred prior to the change, modification or addition. In still further embodiments, a merchant can change and/or modify the merchant offer information 220 at any time and/or create new merchant offer information and can retroactively institute the system and method 100 on transactions which occurred within a prescribed time period prior to the change, modification or addition. In some embodiments, a merchant can have any number of offers and payouts active at any one time, which are logically unique with no conflicting trigger or payout variables. Additionally, the merchant can have any number of accounts or differing liquidity providers identified to facilitate settlement of each individual offer. To facilitate the capture of the examples above and other effective offer/payout combinations, variables to be collected can include, but not be limited to, transaction(s) and associated payout amounts, transaction volume(s), minimum and maximum transaction amounts and/or currencies, minimum and maximum transaction volumes, dates and times associated with triggers and amounts, and liquidity providers, and/or any other known, convenient and/or desired variable that can be used to describe a payout rule.

FIG. 3 depicts an embodiment of the payout/reward system and method of a system and method 100 for delivering rewards to a consumer. In the embodiment depicted in FIG. 3, the payout/reward system can comprise the steps of determining a payout/liquidity provider and amount 302 which can be based, at least in part, on payout information received from steps 212 and/or 222 and offer information received from step 220. In some embodiments, the liquidity/payout provider can be the same as the merchant. However, in alternate embodiments the liquidity/payout provider can be related to or independent from the merchant.

In step 304 the liquidity/payout provider can be charged for the cost of the reward/payout. In some embodiments, the charged amount may be greater than the payout/reward cost and/or can include fees/costs and/or a markup. In step 306 the charged fees from step 304 can be transferred to a payout agent/reward provider and/or a portion can be retained by the operator of the system and method 100. In step 308, the merchant sub-system-and-method 216 and/or the customer sub-system-and-method 206 can be updated and/or alternate customer reward/payout records maintained elsewhere can be updated.

In step 310, a payout decision can be made based at least in part on payout/reward threshold information which can be received and/or retrieved from merchant sub-system-and-method 216 and/or the customer sub-system-and-method 206. In the event, a payout/reward is warranted and/or has not been earned, a payout/reward can be initiated at step 312 and then associated records related to the issuance of the payout/reward can be updated in the merchant sub-system-and-method, the customer sub-system-and-method and/or alternate reward/payout records maintained elsewhere can be updated and the system can then proceed to end 316.

If at step 310 it is determined that a payout/reward is not warranted and/or has not been earned, then the system can proceed to the end step 316. In some embodiments, the system can issue a full or partial credit for the funds transferred in step 306.

In some alternate embodiments step 310 can precede step 304 or 302.

FIG. 3 depicts an embodiment of the payout/reward system and method of a system and method 100 for delivering rewards to a consumer. In the embodiment depicted in FIG. 3, the payout/reward system can comprise the steps of determining a payout/liquidity provider and amount 302 which can be based, at least in part, on payout information received from steps 212 and/or 222 and offer information received from step 220. In some embodiments, liquidity/payout provider can be the same as the merchant. However, in alternate embodiments the liquidity/payout provider can be related to or independent from the merchant.

In the step 302 depicted in FIG. 3. the step of Find Liquidity Provider describes the process wherein offer conditions have been met, and a payout against the specific offer has commenced. Process step Find Liquidity Provider 302 receives the specific Offer Information 222 from the Merchant Database 222. Additionally, merchant information related to the specific offer from the same database 222 including, but not limited to, merchant name, ID, liquidity provider for this specific payment, account details, and payment details can be received. Additionally, customer details relating to any receipt of funds can be transferred from the Customer Database 212, and can include, but are not limited to, customer name, ID, transaction details, and financial account details. In step 226 at Payout Start 226, the liquidity provider and associated financial account details can be identified. As used herein, a liquidity Provider is a generic term that may or may not be an account owned, controlled or managed by the merchant. In some embodiments, the identification of a Liquidity Provider 302 can comprise offers specifically sponsored by a merchant's vendor, and by way of non-limiting example, a bar may be offering a happy-hour from 6 pm to 8 pm sponsored by a beer manufacturer, and any purchase made between these hours could result in a 20% discount off the purchase price. Such an example could be considered a vendor sponsored program and the liquidity provider could be identified as the beer manufacturer itself, and as such their account could be debited directly to facilitate the promotion.

In the step 304 depicted in FIG. 3. the step of Charge Liquidity Provider describes the process wherein the liquidity provider can be charged the amount associated with the individual identified offer payouts. This process can be implemented on a transaction-by-transaction basis, accumulated daily, weekly, monthly or any time period including manually initiated. On initiating step 304, Charge Liquidity Provider, the specified internal financial account details associated with the merchant's offer can be adjusted, and await the initiation of step 306, Transfer Funds.

In the step 306 depicted in FIG. 3. the step of Transfer Funds describes the process wherein the liquidity provider's financial account or payment method associated with the individual identified offer payouts can be charged the associated amount accumulated in Charge Liquidity Provider step 304. This process can be implemented on a transaction-by-transaction basis, accumulated daily, weekly, monthly or any time period including manually initiated. On triggering a transfer, the specific financial account or associated payment method with the merchant's offer can be initiated. The transfer amounts can be automatically passed from the associated merchant liquidity provider accounts adjusted in step 304, and merchant processing, direct account debiting, and/or any other financial transfer mechanism can be processed. The funds can be transferred directly to the customer, a company holding account and/or a third-party account. In some embodiments the liquidity provider's funds can be transferred to the company's holding account awaiting decision as to whether certain criteria for payout release of funds has been met, such as minimum balances, or specific offers based on accumulated balances.

In the step 308 depicted in FIG. 3. the step of Adjust Customer Balance describes the process by which customer balances can be adjusted by the payout associated with the triggered offer. Customer Balance Information 206 can be recalled from the Customer Database 212, along with the transaction details, merchant information pertinent to the transaction can also be recalled via 216. A number of variables can be used as triggers for this decision and they can include, but not be limited to, payout threshold amounts, offers requiring payout over specific timeframes, offers tied to multiple purchase thresholds, offers requiring multiple different merchant purchases, offers based on total merchant accumulated sales over a specific time period, and/or any method of payment aggregation previously agreed upon by the customer when accepting either the terms of service or any specific offer. With all associated information available, adjustments to a customer's account balance can be made.

In step 310 depicted in FIG. 3. the step of Payout Decision describes the process by which a decision can be made to initiate transfer of funds to the customer's financial account. A number of variables can be used as triggers for this decision and they can include, but not be limited to, payout threshold amounts, offers requiring payout over specific timeframes, offers tied to multiple purchase thresholds, offers requiring multiple different merchant purchases, offers based on total merchant accumulated sales over a specific time period, and/or any method of payment aggregation previously agreed upon by the customer when accepting either the terms of service or any specific offer. If the Payout Decision 310 is positive, transfer of physical funds can be automatically initiated, and if not, then the customer balance remains adjusted and awaits appropriate conditions to be met for physical payout or transfer.

In the step 312 depicted in FIG. 3. the step of Transfer Funds to Consumer describes the process wherein payment can be initiated to the customer financial account or any other payment method chosen by the customer. These funds can be transferred directly from the merchant, a company holding account or a third-party account. The methods of funds transfer are well documented, and can include direct deposit, check, credit or debit card reimbursement, or any other known or future fund transfer mechanism.

In the step 314 depicted in FIG. 3. the step of Adjust Consumer describes the process wherein after the funds transfer has been successful completed, the customer balance can be adjusted accordingly to reflect the associated payment in 312. This data can be stored in Customer Database 212.

In the step 316 depicted in FIG. 3. the step of End describes the conditions to stop the process of providing a payout. The process can stop when there are no more consumer transactions left to process, or at will when triggered manually or automatically. End can additionally be triggered by event handling routines that identify, but not limited to, situations such as fund transfer failure, account attachment failure, merchant processing failure, account not active failure, and/or general failure.

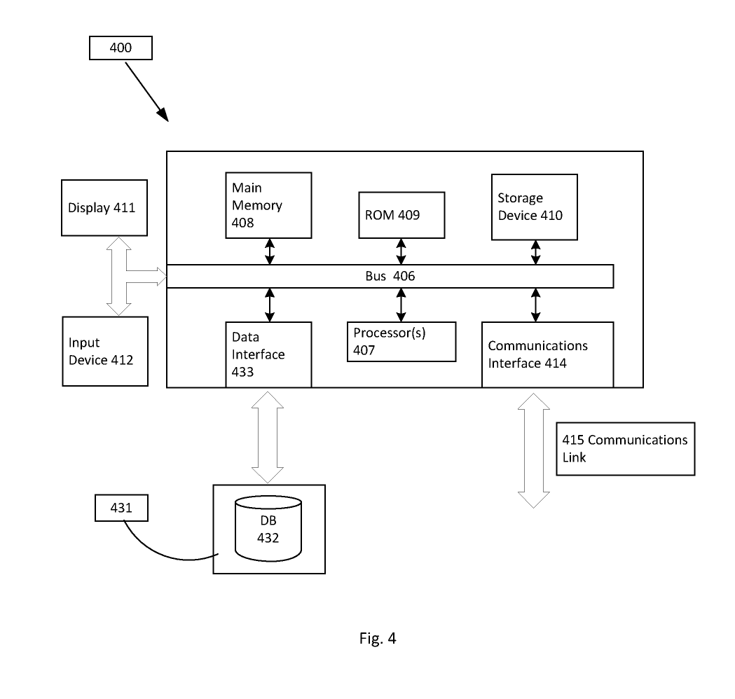

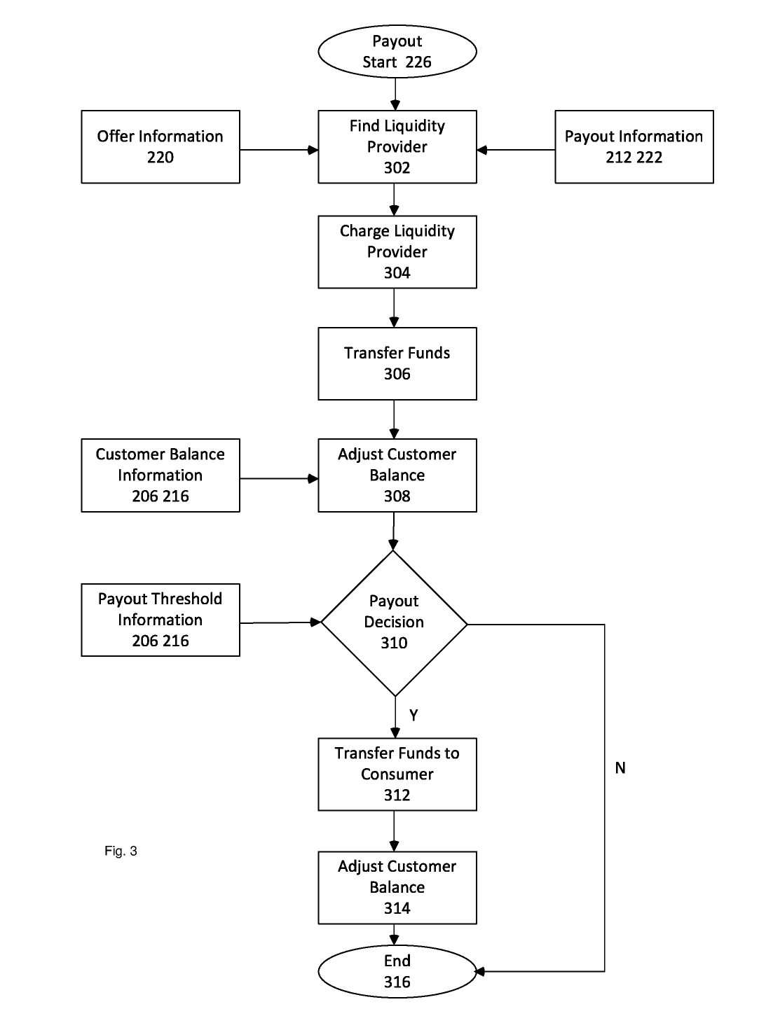

The execution of the sequences of instructions required to practice the embodiments can be performed by a computer system 400 as shown in FIG. 4. In an embodiment, execution of the sequences of instructions is performed by a single computer system 400. According to other embodiments, two or more computer systems 400 coupled by a communication link 415 can perform the sequence of instructions in coordination with one another. Although a description of only one computer system 400 will be presented below, however, it should be understood that any number of computer systems 400 can be employed to practice the embodiments.

A computer system 400 according to an embodiment will now be described with reference to FIG. 4, which is a block diagram of the functional components of a computer system 400. As used herein, the term computer system 400 is broadly used to describe any computing device that can store and independently run one or more programs.

Each computer system 400 can include a communication interface 414 coupled to the bus 406. The communication interface 414 provides two-way communication between computer systems 400. The communication interface 414 of a respective computer system 400 transmits and receives electrical, electromagnetic or optical signals that include data streams representing various types of signal information, e.g., instructions, messages and data. A communication link 415 links one computer system 400 with another computer system 400. For example, the communication link 415 can be a LAN, in which case the communication interface 414 can be a LAN card, or the communication link 415 can be a PSTN, in which case the communication interface 414 can be an integrated services digital network (ISDN) card or a modem, or the communication link 415 can be the Internet, in which case the communication interface 414 can be a dial-up, cable or wireless modem.

A computer system 400 can transmit and receive messages, data, and instructions, including program, i.e., application, code, through its respective communication link 415 and communication interface 414. Received program code can be executed by the respective processor(s) 407 as it is received, and/or stored in the storage device 410, or other associated non-volatile media, for later execution.

In an embodiment, the computer system 400 operates in conjunction with a data storage system 431, e.g., a data storage system 431 that contains a database 432 that is readily accessible by the computer system 400. The computer system 400 communicates with the data storage system 431 through a data interface 433. A data interface 433, which is coupled to the bus 406, transmits and receives electrical, electromagnetic or optical signals that include data streams representing various types of signal information, e.g., instructions, messages and data. In embodiments, the functions of the data interface 433 can be performed by the communication interface 414.

Computer system 400 includes a bus 406 or other communication mechanism for communicating instructions, messages and data, collectively, information, and one or more processors 407 coupled with the bus 406 for processing information. Computer system 400 also includes a main memory 408, such as a random access memory (RAM) or other dynamic storage device, coupled to the bus 406 for storing dynamic data and instructions to be executed by the processor(s) 407. The main memory 408 also can be used for storing temporary data, i.e., variables, or other intermediate information during execution of instructions by the processor(s) 407.

The computer system 400 can further include a read only memory (ROM) 409 or other static storage device coupled to the bus 406 for storing static data and instructions for the processor(s) 407. A storage device 410, such as a magnetic disk or optical disk, can also be provided and coupled to the bus 406 for storing data and instructions for the processor(s) 407.

A computer system 400 can be coupled via the bus 406 to a display device 411, such as, but not limited to, a cathode ray tube (CRT) or a liquid-crystal display (LCD) monitor, for displaying information to a user. An input device 412, e.g., alphanumeric and other keys, is coupled to the bus 406 for communicating information and command selections to the processor(s) 407.

According to one embodiment, an individual computer system 400 performs specific operations by their respective processor(s) 407 executing one or more sequences of one or more instructions contained in the main memory 408. Such instructions can be read into the main memory 408 from another computer-usable medium, such as the ROM 409 or the storage device 410. Execution of the sequences of instructions contained in the main memory 408 causes the processor(s) 407 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 407. Such a medium can take many forms, including, but not limited to, non-volatile, volatile and transmission media. Non-volatile media, i.e., media that can retain information in the absence of power, includes the ROM 409, CD ROM, magnetic tape, and magnetic discs. Volatile media, i.e., media that cannot retain information in the absence of power, includes the main memory 408. Transmission media includes coaxial cables, copper wire and fiber optics, including the wires that comprise the bus 406. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

Although exemplary embodiments of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed is:

1. A system for determining consumer rewards comprising:
Accessing consumer financial institution information comprising one or more transactions;
Receiving merchant reward offer information comprising one or more reward conditions and one or more reward values;
Determining whether said one or more transactions correspond to said one or more reward conditions; and
Delivering a reward based at least in part on said one or more transactions, said one or more reward conditions and said one or more reward values.
